(19) United States
(12) Patent Application Publication
(10) Pub. No.: US 2011/0070399 A1
(43) Pub. Date: Mar. 24, 2011

(54) SUBSTRATE FOR DISPLAY PANEL, DISPLAY PANEL INCLUDING THE SUBSTRATE, METHOD FOR MANUFACTURING THE SUBSTRATE, AND METHOD FOR MANUFACTURING THE DISPLAY PANEL

(76) Inventor: Hideaki Sunohara, Osaka (JP)

(21) Appl. No.: 12/993,762

(22) PCT Filed: Apr. 22, 2009
(86) PCT No.: PCT/JP2009/057955

§ 371 Date: Nov. 19, 2010

(30) Foreign Application Priority Data
May 20, 2008 (JP) 2008-131445

(51) Int. Cl. B32B 3/24; B05D 5/12; H01J 9/00

(52) U.S. Cl. 428/138; 427/58; 445/24

(57) ABSTRACT

A substrate for a display panel that is capable of increasing an auxiliary capacitance of a capacitor without increasing an outside dimension of the capacitor. The substrate includes a first conductive film (141), a second conductive film (142) that is superimposed on the first conductive film (141) and includes an opening, and second and third insulating films (18) (19) that are superimposed on the first and second conductive films (141) (142) and each include openings (contact holes), the first conductive film (141) being exposed from the openings of the second conductive film (142) and the second and third insulating films (18) (19), a rim of the opening of the second conductive film (142) being covered with a protruding portion (191) of the third insulating film (19).

### TECHNICAL FIELD

The present invention relates to a substrate for a display panel, a display panel including the substrate, a method for manufacturing the substrate, and a method for manufacturing the display panel. The present invention specifically relates to a substrate for a display panel such as a substrate for a liquid crystal display panel that has a laminated structure of a conductive film, a semiconductive film and an insulating film that have given patterns, a display panel including the substrate, a method for manufacturing the substrate, and a method for manufacturing the display panel.

### BACKGROUND ART

A general active matrix liquid crystal display panel includes a TFT array substrate and a common substrate. The TFT array substrate and the common substrate are disposed opposed to each other leaving a given small gap therebetween, and liquid crystals are filled between the substrates.

A plurality of pixel electrodes are arranged in a matrix on the TFT array substrate. TFTs (Thin Film Transistors) are arranged in a matrix on the TFT array substrate in a layer different from a layer where the pixel electrodes are provided, interposing a given insulating film between the layers. Drain electrodes of the TFTs are electrically connected with the pixel electrodes by drain lines (the drain lines may be regarded as extensions of the drain electrodes). Thus, the TFTs can each drive the pixel electrodes.

For example, there is a configuration such that a layer in which the insulating film is provided is provided between the layer in which the TFTs and the drain lines are provided and the layer where the pixel electrodes are provided. In this configuration, openings (contact holes) are provided in the insulating film, and electric current passes between the drain lines and the pixel electrodes through the contact holes. To be specific, the drain lines and the pixel electrodes are in physical contact with each other at the openings (contact holes) provided in the layer of the insulating film.

The drain lines sometimes have a laminated structure of a variety of conductors that have different ionization tendencies. Examples of the laminated structure include a two-layer structure of titanium and aluminum. When the layer that is in physical contact with the pixel electrodes is made of a material having a high ionization tendency, electrolytic corrosion could occur between the pixel electrodes and the material. If the electrolytic corrosion occurs, the material that is in physical contact with the pixel electrodes undergoes oxidation to cause a reaction to reduce a material of which the pixel electrodes are made. Consequently, the electric current between the drain lines and the pixel electrodes stops, and signals cannot be normally transmitted to the pixel electrodes.

The following is a configuration found in order to prevent electrolytic corrosion from occurring between the drain lines and the pixel electrodes. FIGS. 9A to 9C are views schematically showing a conventional example of a configuration of a connecting portion between a drain line in a TFT and a pixel electrode. FIG. 9A is an external perspective view showing the same. FIG. 9B is a cross-sectional view showing the same along the line A-A of FIG. 9A. FIG. 9C is a cross-sectional view showing the same along the line B-B of FIG. 9A. It is to be noted that the pixel electrode is omitted from FIG. 9A.

As shown in FIGS. 9A to 9C, an elongate through hole that penetrates all the layers is provided in the drain line. In addition, an elongate opening (contact hole) is provided in a layer in which an insulating film is provided. The elongate through hole of the drain line intersects the elongate opening (contact hole) of the insulating film layer. An upper layer of the drain line is exposed from the opening (contact hole) of the insulating film layer, and a material in the upper layer at the exposed site is removed and a lower layer of the drain line is exposed there. The pixel electrode is provided on the lower layer at the exposed site.

With this configuration, signals transmitted from the drain electrode of the TFT can be transmitted to the pixel electrode through the lower layer of the drain line. Because the lower layer of the drain line is in physical contact with the pixel electrode while the upper layer of the drain line is not in physical contact with the pixel electrode, electrolytic corrosion can be prevented from occurring between the upper layer of the drain line and the pixel electrode.

However, this configuration sometimes causes the following problem. In the configuration that the through hole is provided in the drain line, if the drain line functions as a capacitor, the portion of the through hole does not function as the capacitor, so that an outside dimension of the drain line needs to be increased in order to increase an auxiliary capacitance of the capacitor. However, if the outside dimension of the drain line is increased, an aperture ratio of a pixel could fall because of prevention of light-transmittance by the drain line.

In addition, in the configuration that the through hole of the drain line intersects the opening (contact hole) of the insulating film layer, there arises another problem that high positioning accuracy needs to be maintained in steps of forming the drain line and forming the insulating film layer, which could lower dimensional tolerances of the drain line and the insulating film layer.

### CITATION LIST

### Patent Literature

PTL 1: WO2007/069362

### SUMMARY OF INVENTION

### Technical Problem

An object of the invention is to overcome the problems described above and to provide a substrate for a display panel that is capable of increasing an auxiliary capacitance of a capacitor without increasing an outside dimension of the capacitor, a display panel including the substrate, a method for manufacturing the substrate, and the method for manufacturing the display panel. Another object of the invention is to overcome the problems described above and to provide a substrate for a display panel that is capable of reducing an outside dimension of an capacitor without reducing an auxiliary capacitance of the capacitor, a display panel including the substrate, a method for manufacturing the substrate, and a method for manufacturing the display panel. Another object of the invention is to overcome the problems described above and to provide a substrate for a display panel that is capable of extending design tolerances of drain lines and pixel electrodes, a display panel including the substrate, a method for manufacturing the substrate, and a method for manufacturing the display panel.

### Solution to Problem

In order to overcome the problems described above, one of preferred embodiments of the present invention provides a substrate for a display panel that includes a first conductive film, a second conductive film that is superimposed on the first conductive film and includes an opening, and an insulating film that is superimposed on the second conductive film and includes an opening, the first conductive film being exposed from the openings of the second conductive film and the insulating film, a rim of the opening of the second conductive film being covered with the insulating film.

It is preferable that a rim of the opening of the insulating film is in contact with the first conductive film.

It is preferable that a rim of the opening of the insulating film includes a portion having the shape of an eave that protrudes further than the rim of the opening of the second conductive film, and the eave-shaped portion covers the rim of the opening of the second conductive film. In addition, it is preferable that the eave-shaped portion is in contact with the first conductive film. In addition, it is preferable that the insulating film has a laminated structure and includes a lower insulating film and an upper insulating film, the rim of the opening of the lower insulating film and the rim of the opening of the second conductive film being covered with the upper insulating film.

It is preferable that the substrate further includes a third conductive film that is superimposed on the insulating film, and is electrically connected with the first conductive film at the openings of the insulating film and the second conductive film.

The first conductive film and the second conductive film may each include portions of a drain line, and the insulating film may be a passivation film. In addition, the third conductive film may be a pixel electrode.

The first conductive film and the second conductive film may be made of materials that have different ionization tendencies. In addition, the upper insulating film may be made of a resin material.

Another preferred embodiment of the present invention provides a substrate for a display panel that includes a conductive film that has a laminated structure and includes a lower sub-conductive film and an upper sub-conductive film, the upper sub-conductive film including an opening, and an insulating film that includes a portion that is superimposed on the conductive film and an opening, the lower sub-conductive film being exposed from the openings of the upper sub-conductive film and the insulating film, a rim of the opening of the upper sub-conductive film being covered with the insulating film.

It is preferable that a rim of the opening of the insulating film is in contact with the lower sub-conductive film.

It is preferable that a rim of the opening of the insulating film includes a portion having the shape of an eave that protrudes further than the rim of the opening of the upper sub-conductive film, and the eave-shaped portion covers the rim of the opening of the upper sub-conductive film. In addition, it is preferable that the eave-shaped portion is in contact with the lower sub-conductive film.

It is preferable that the insulating film has a laminated structure and includes a lower insulating film and an upper insulating film, the rim of the opening of the lower insulating film and the rim of the opening of the upper sub-conductive film being covered with the upper insulating film.

It is preferable that the substrate further includes a third conductive film that is superimposed on the insulating film, and is electrically connected with the lower sub-conductive film at the openings of the insulating film and the upper sub-conductive film.

The lower sub-conductive film and the upper sub-conductive film may each include portions of a drain line, and the insulating film may be a passivation film. The third conductive film may be a pixel electrode.

It is preferable that the lower sub-conductive film and the upper sub-conductive film are made of materials that have different ionization tendencies.

It is preferable that the upper insulating film is made of a resin material.

Another preferred embodiment of the present invention provides a display panel that includes the substrate described above, a common substrate that is opposed to the substrate, leaving a given gap therebetween, and liquid crystals that are filled between the substrates.

Another preferred embodiment of the present invention provides a method for manufacturing a substrate for a display panel that includes the steps of forming a first conductive film, forming a second conductive film that is superimposed on the first conductive film, forming an insulating film that includes a portion superimposed on the second conductive film, forming an opening in the insulating film, forming an opening in the second conductive film to expose the first conductive film, and thermally deforming the insulating film and covering a rim of the opening of the second conductive film with a rim of the opening of the insulating film.

Another preferred embodiment of the present invention provides a method for manufacturing a substrate for a display panel that includes the steps of forming a first conductive film, forming a second conductive film that is superimposed on the first conductive film, forming an insulating film that includes a portion superimposed on the second conductive film, forming an opening in the insulating film, forming an opening in the second conductive film to expose the first conductive film, and thermally deforming the insulating film, covering a rim of the opening of the second conductive film with a rim of the opening of the insulating film, and bringing the rim of the opening of the insulating film into contact with the exposed first conductive film.

Another preferred embodiment of the present invention provides a method for manufacturing a substrate for a display panel that includes the steps of forming a conductive film that includes a lower sub-conductive film and an upper sub-conductive film, forming an insulating film that includes a portion superimposed on the conductive film, forming an opening in the insulating film, forming an opening in the upper sub-conductive film to expose the lower sub-conductive film, and thermally deforming the insulating film and covering a rim of the opening of the upper sub-conductive film with a rim of the opening of the insulating film.

Another preferred embodiment of the present invention provides a method for manufacturing a substrate for a display panel that includes the steps of forming a conductive film that includes a lower sub-conductive film and an upper sub-conductive film, forming an insulating film that includes a portion superimposed on the conductive film, forming an opening in the insulating film, forming an opening in the upper sub-conductive film to expose the lower sub-conductive film, and thermally deforming the insulating film, covering a rim of the opening of the upper sub-conductive film with a rim of the opening of the insulating film and bringing the rim of the opening of the insulating film into contact with the exposed lower sub-conductive film.

### ADVANTAGEOUS EFFECTS OF INVENTION

According to the preferred embodiments of the present invention, it is unnecessary to provide an opening in a drain line. Consequently, an auxiliary capacitance of the drain line can be increased without increasing an outside dimension of a portion of the drain line, the portion superimposing an auxiliary capacitance line. In addition, the auxiliary capacitance of the drain line can be prevented from reducing even when the outside dimension is reduced.

In addition, because it is unnecessary to provide an opening in the drain line, a need to have a configuration such that an opening of the drain line intersects an opening (contact hole) of an insulating film layer is eliminated. Consequently, dimensional tolerances of the drain line and the insulating film layer can be extended.

### BRIEF DESCRIPTION OF DRAWINGS

FIG. 1 is a plan view showing an enlarged schematic configuration of a pixel electrode of one pixel and one TFT among pixels and TFTs provided on a substrate for a display panel according to one preferred embodiment of the present invention.

FIG. 2 is a cross-sectional view showing the configuration along the line A-A of FIG. 1.

FIGS. 3A and 3B are cross-sectional views schematically showing steps of a method for manufacturing the substrate.

FIGS. 4A and 4B are cross-sectional views schematically showing steps of the method for manufacturing the substrate.

FIGS. 5A and 5B are cross-sectional views schematically showing steps of the method for manufacturing the substrate.

FIG. 6 is a cross-sectional view schematically showing a step of the method for manufacturing the substrate.

FIG. 7 is an external perspective view showing a schematic configuration of a display panel including the substrate according to the preferred embodiment of the present invention.

FIGS. 8A, 8B and 8C are views showing a schematic configuration of a common substrate (color filter). FIG. 8A is a perspective view showing a schematic configuration of the entire common substrate (color filter). FIG. 8B is a plan view showing a configuration of one pixel among pixels provided on the common substrate (color filter). FIG. 8C is a cross-sectional view showing a cross-sectional configuration of the pixel along the line B-B of FIG. 8B.

FIGS. 9A, 9B and 9C are views schematically showing a conventional example of a configuration of a connecting portion between a drain line in a TFT and a pixel electrode. FIG. 9A is an external perspective view showing the same. FIG. 9B is a cross-sectional view showing the same along the line A-A of FIG. 9A. FIG. 9C is a cross-sectional view showing the same along the line B-B of FIG. 9A.

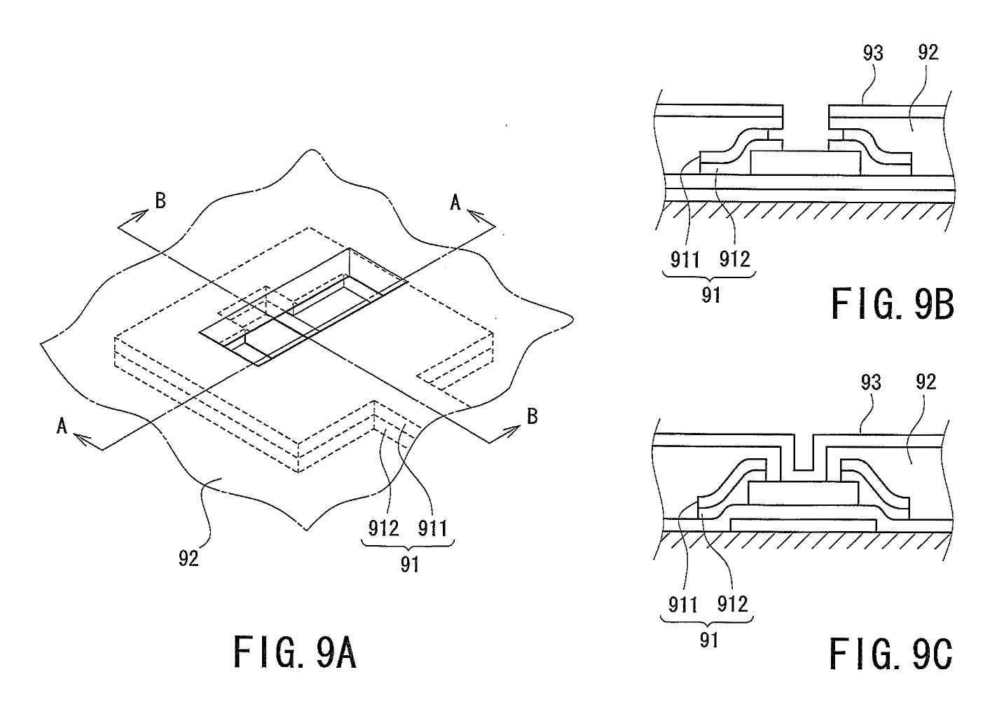

### DESCRIPTION OF EMBODIMENTS

Detailed descriptions of preferred embodiments of the present invention will now be provided with reference to the accompanying drawings.

A substrate for a display panel according to one of the preferred embodiments of the present invention is a TFT array substrate for an active matrix liquid crystal display panel. The TFT array substrate includes a plurality of pixel electrodes arranged in a matrix, TFTs (Thin Film Transistors) arranged to each drive the pixel electrodes, and given lines.

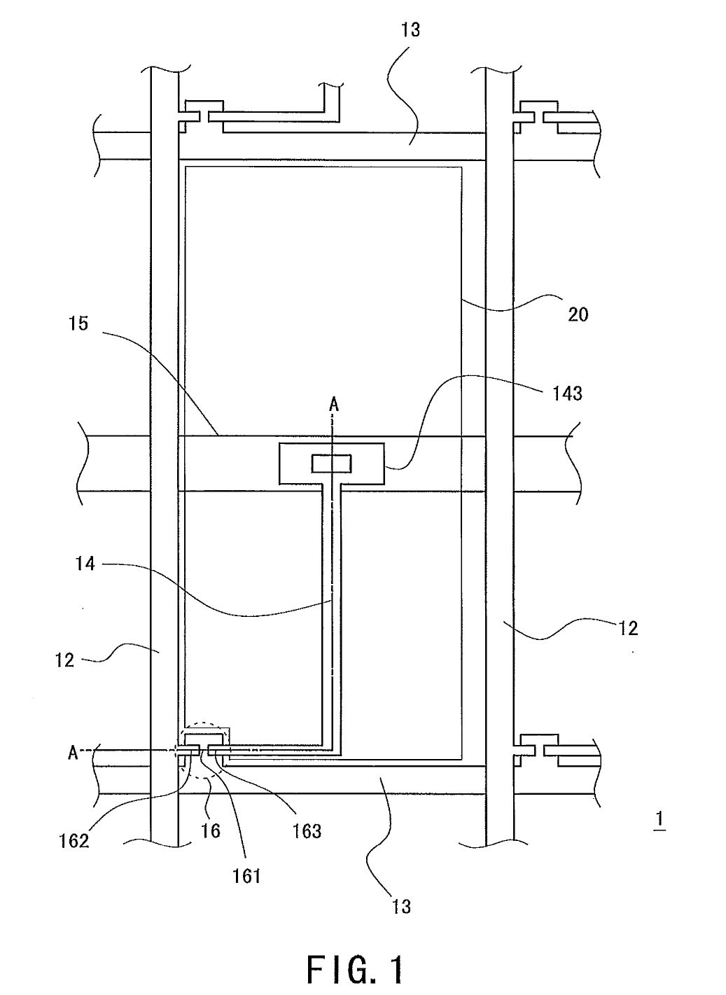

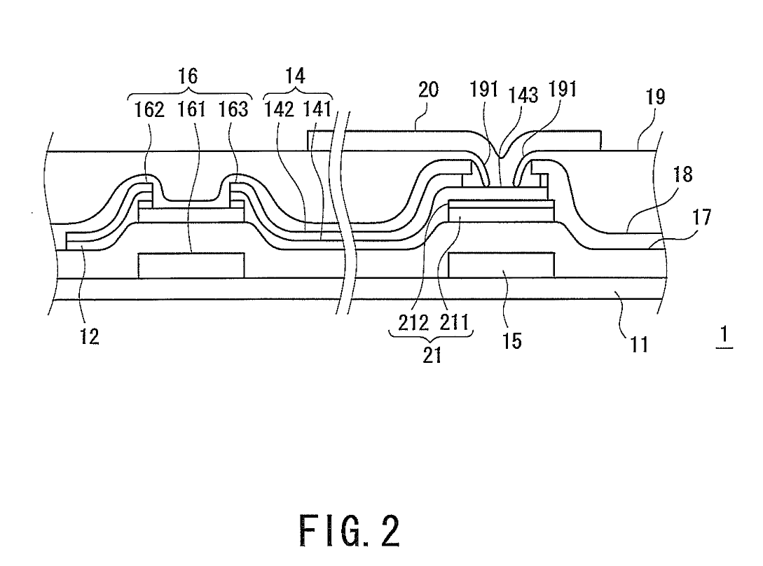

FIG. 1 is a plan view showing an enlarged schematic configuration of a pixel electrode of one pixel and one TFT among the pixels and the TFTs on the substrate according to the preferred embodiment of the present invention. FIG. 2 is a cross-sectional view showing the configuration along the line A-A of FIG. 1.

As shown in FIG. 1 and FIG. 2, in the configuration of the pixel electrode of the one pixel and the one TFT, a substrate 1 for a display panel according to the preferred embodiment of the present invention includes a transparent substrate 11, a data line (also referred to as a source line) 12, a scanning line (also referred to as a gate line) 13, a drain line 14, an auxiliary capacitance signal line 15, a TFT 16, a first insulating film 17, a second insulating film 18, a third insulating film 19, a pixel electrode 20, and a semiconductive film 21. The TFT 16 includes a gate electrode 161, a source electrode 162, and a drain electrode 163.

As shown in FIG. 2, the drain line 14 has a laminated structure of at least two kinds of conductive films 141 and 142 that are made of materials having different ionization tendencies. In the substrate 1 according to the preferred embodiment of the present invention, the drain line 14 has a two-layer structure. The conductive film 141 of the drain line 14 that is closer to the transparent substrate 11 is referred to as a “first sub-conductive film” and the conductive film 142 of the drain line 14 that is closer to the pixel electrode 20 is referred to as a “second sub-conductive film”. In the preferred embodiment of the present invention, the number of layers of the laminated structure of the drain line 14 is not limited to two, and may be three or more.

The first sub-conductive film 141 and the second sub-conductive film 142 are in physical contact with each other to be electrically connected. The materials of which the first sub-conductive film 141 and the second sub-conductive film 142 are made have different ionization tendencies. To be specific, the material of which the first sub-conductive film 141 is made has an ionization tendency lower than the material of which the second sub-conductive film 142 is made. Examples of the material of which the first sub-conductive film 141 is made include titanium and chromium, and examples of the material of which the second sub-conductive film 142 is made include aluminum and an aluminum alloy.

As shown in FIG. 1 and FIG. 2, one end of the drain line 14 is electrically connected with the drain electrode 163 of the TFT 16. The other end of the drain line 14 is provided with a pad portion 143, and electrically connected with the pixel electrode 20. With this configuration, the drain line 14 is capable of transmitting electrical signals outputted from the drain electrode 163 of the TFT 16 to the pixel electrode 20.

A portion where the drain line 14 and the pixel electrode 20 are electrically connected has a configuration as follows.

As shown in FIG. 1 and FIG. 2, the auxiliary capacitance signal line 15 having a given shape is provided on one surface of the transparent substrate 11. The first insulating film 17 is provided so as to cover the auxiliary capacitance signal line 15. The semiconductive film 21 is provided on the first insulating film 17 at a position such that the semiconductive film 21 is superimposed on the auxiliary capacitance signal line 15, interposing the first insulating film 17 therebetween. For example, the semiconductive film 21 has a two-layer structure of a first sub-semiconductive film 211 and a second sub-semiconductive film 212.

The drain line 14 is provided on the first insulating film 17. The pad portion 143 provided at the other end of the drain line 14 is superimposed on the semiconductive film 21, and is also superimposed on the auxiliary capacitance signal line 15, interposing the semiconductive film 21 and the first insulating film 17 therebetween. With this configuration that the pad portion 143 of the drain line 14 and the auxiliary capacitance signal line 15 are opposed to each other, interposing the first insulating film 17 and the semiconductive film 21 therebetween, a capacitor is provided.

The pad portion 143 of the drain line 14 includes a portion where the second sub-conductive film 142 is not provided. To be specific, on the pad portion 143 of the drain line 14, the second sub-conductive film 142 has an opening. The drain line 14 has a one-layer structure of the first sub-conductive film 141 at the portion where the second sub-conductive film 142 is not provided (i.e., the portion where the second sub-conductive film 142 has the opening).

The second insulating film 18 is provided so as to cover the drain line 14, the semiconductive film 21, and the first insulating film 17. The third insulating film 19 is provided so as to cover the second insulating film 18. The second insulating film 18 is preferably made of SiNx (silicon nitride). The third insulating film 19 is preferably made of an acrylic resin material.

The second insulating film 18 and the third insulating film 19 have openings (contact holes) of given sizes at a given position. Viewed in a direction perpendicular to a surface of the substrate 1 according to the preferred embodiment of the present invention (i.e., in a direction of the normal to the surface), the opening (contact hole) of the second insulating film 18 has a circumference (rim) that substantially corresponds to the circumference of the opening of the second sub-conductive film 142 that is provided on the pad portion 143 of the drain line 14. Alternatively, the circumference of the opening (contact hole) of the second insulating film 18 is smaller and located inner than the circumference of the opening of the second sub-conductive film 142. Shown in FIG. 1 and FIG. 2 is a configuration such that the circumference of the opening (contact hole) of the second insulating film 18 is smaller and located inner than the circumference of the opening of the second sub-conductive film 142 that is provided on the pad portion 143 of the drain line 14.

The circumference (rim) of the opening (contact hole) of the third insulating film 19 is smaller and located inner than the circumference (rim) of the opening (contact hole) of the second insulating film 18. Thus, as shown especially in FIG. 2, the second insulating film 18 includes a portion having the shape of an eave that protrudes inward further than the circumference (rim) of the opening (contact hole) of the second sub-conductive film 142 of the drain line 14.

The third insulating film 19 includes a protruding portion 191 having the shape of an eave that protrudes inward further than the circumferences of the opening of the second sub-conductive film 142 and the opening (contact hole) of the second insulating film 18. To be specific, the protruding portion 191 protrudes further than the circumferences (rims) of the opening of the second sub-conductive film 142 and the opening (contact hole) of the second insulating film 18 toward the center of the openings.

The end of the protruding portion 191 bends toward the drain line 14. The end of the protruding portion 191 is in physical contact with the first sub-conductive film 141 of the drain line 14. Thus, the inside surface (rim) of the opening of the second sub-conductive film 142 of the drain line 14 is covered with the protruding portion 191 of the third insulating film 19.

The pixel electrode 20 is provided on the third insulating film 19. The pixel electrode 20 is preferably made of ITO (Indium Tin Oxide). The pixel electrode 20 is provided on the protruding portion 191 of the third insulating film 19, and is also provided on the first sub-conductive film 141 of the drain line 14 that is exposed from the openings (contact holes) of the second insulating film 18 and the third insulating film 19.

With this configuration, the pixel electrode 20 and the first sub-conductive film 141 of the drain line 14 are in physical contact with each other at the openings (contact holes) of the second insulating film 18 and the third insulating film 19 to be electrically connected. Meanwhile, because the inside surface of the opening of the second sub-conductive film 142 of the drain line 14 is covered with the protruding portion 191 of the third insulating film 19, the second sub-conductive film 142 is not exposed from the openings (contact holes) of the second insulating film 18 and the third insulating film 19. Consequently, the pixel electrode 20 and the second sub-conductive film 142 of the drain line 14 are not in physical contact with each other.

In this configuration, the second sub-conductive film 142 (i.e., the sub-conductive film that is made of the material having the higher ionization tendency) of the drain line 14 is not in physical contact with the pixel electrode 20. Thus, electrolytic corrosion can be prevented from occurring between the second sub-conductive film 142 and the pixel electrode 20. In a case where the pixel electrode 20 is made of ITO and the second sub-conductive film 142 of the drain line 14 is made of aluminum, the aluminum sometimes undergoes oxidation to cause a reaction to reduce the ITO when the pixel electrode 20 and the second sub-conductive film 142 of the drain line 14 are brought into physical contact with each other. However, having the configuration described above, the substrate 1 according to the preferred embodiment of the present invention can prevent such a reaction because the pixel electrode 20 and the second sub-conductive film 142 of the drain line 14 are not in physical contact with each other.

The configuration allows the electrical connection between the drain line 14 and the pixel electrode 20 without providing such an opening as provided in a conventional substrate that penetrates both of the first sub-conductive film 141 and the second sub-conductive film 142 at the pad portion 143 of the drain line 14. Consequently, an outside dimension of the pad portion 143 of the drain line 14 can be reduced while an auxiliary capacitance of the pad portion 143 is maintained. Alternatively, the auxiliary capacitance of the pad portion 143 can be increased while the outside dimension of the pad portion 143 is maintained.

In addition, it is unnecessary to provide a through hole in the pad portion 143 of the drain line 14 and make the through hole intersect the openings (contact holes) of the second insulating film 18 and the third insulating film 19. It is essential only that the openings (contact holes) of the second insulating film 18 and the third insulating film 19 should be disposed on the pad portion 143 of the drain line 14. Consequently, dimensional tolerances of the drain line 14, the second insulating film 18, and the third insulating film 19 can be extended.

Next, a description of a method for manufacturing the substrate 1 according to the preferred embodiment of the present invention will be provided.

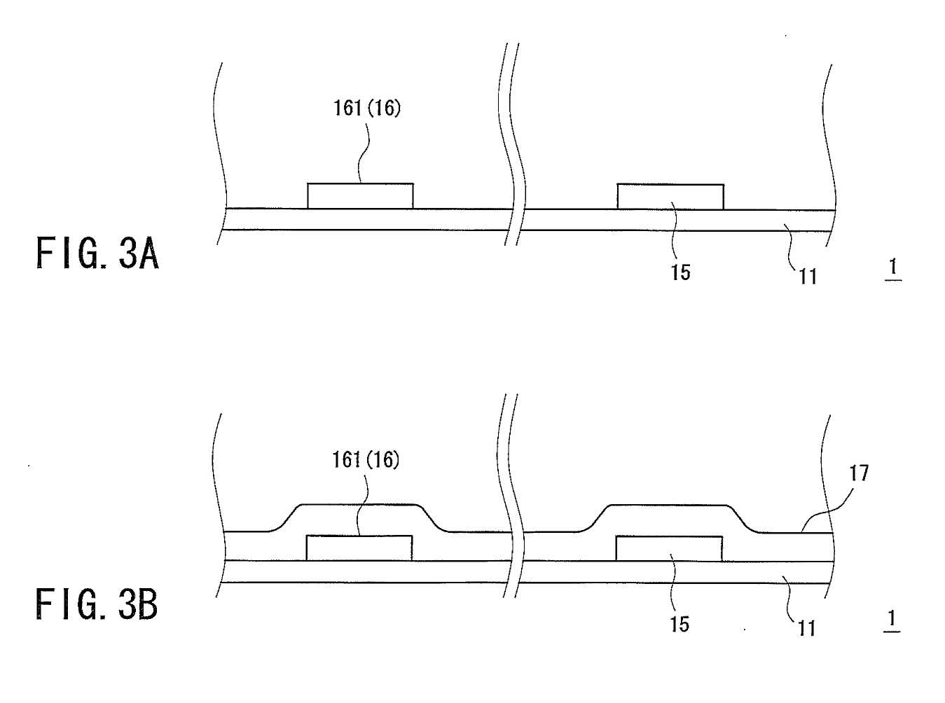

FIGS. 3A and 3B, 4A and 4B, 5A and 5B, and 6 are cross-sectional views schematically showing steps of the method for manufacturing the substrate 1 according to the preferred embodiment of the present invention. In the cross-sectional views, shown is the configuration along the line A-A of FIG. 1.

First, as shown in FIG. 3A, the scanning line 13 (not shown), the auxiliary capacitance signal line 15, and the gate electrode 161 of the TFT 16 are formed on the one surface of the transparent substrate 11.

To be specific, a conductive film (hereinafter, referred to as a “first conductive film”) that is single-layer or multilayer and preferably made of chromium, tungsten, molybdenum and aluminum is formed on the one surface of the transparent substrate 11. The first conductive film is formed preferably using a known sputtering method. The thickness of the first conductive film is not limited specifically. For example, the first conductive film may have a thickness of about 300 nm.

Then, the formed first conductive film is subjected to patterning so as to have the shapes of the scanning line 13, the auxiliary capacitance signal line 15, and the gate electrode 161 of the TFT 16. Examples of the patterning of the first conductive film include known etching such as dry etching using Cl₂ gas, and wet etching using HNO₃+HClO₄. After the patterning of the first conductive film, the scanning line 13 (not shown), the auxiliary capacitance signal line 15, and the gate electrode 161 of the TFT 16 having the respective shapes are formed on the one surface of the transparent substrate 11 as shown in FIG. 3A.

Then, as shown in FIG. 3B, the first insulating film (i.e., gate insulating film) 17 is formed on the one surface of the transparent substrate 11 subjected to the precedent stage. The first insulating film 17 is preferably made of SiNx (silicon nitride) and has a thickness of about 300 nm. The first insulating film (gate insulating film) 17 is formed preferably using a plasma CVD method, in which the material (e.g., silicon nitride) of the first insulating film 17 is deposited on the one surface of the transparent substrate 11. By the formed first insulating film (gate insulating film) 17, the scanning line 13, the auxiliary capacitance signal line 15, and the gate electrode 161 of the TFT 16, which are formed in the precedent stage, are covered.

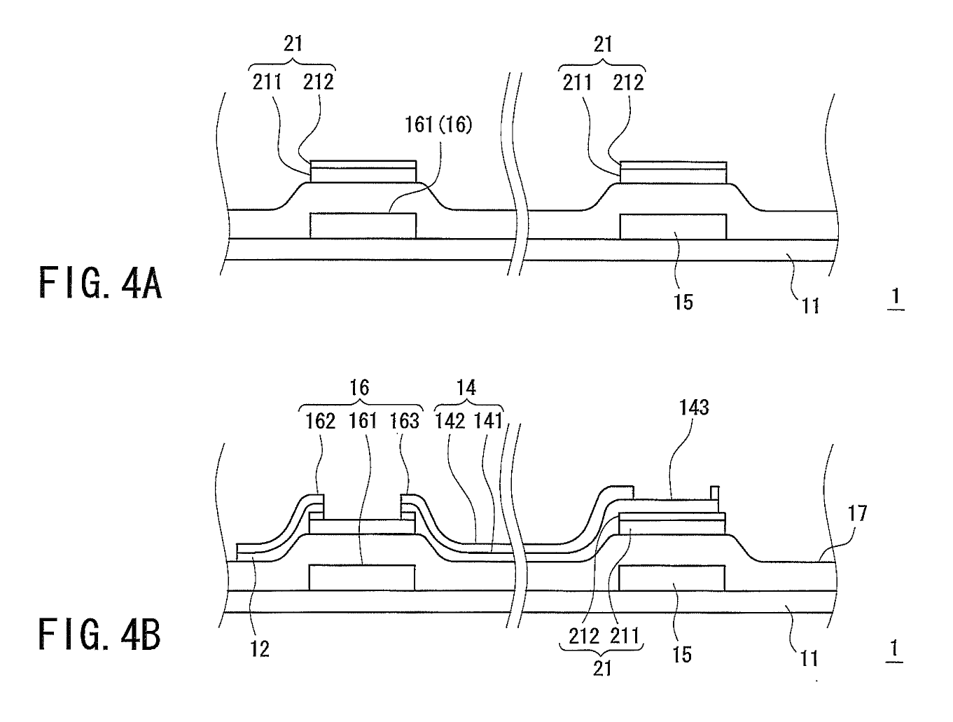

Next, as shown in FIG. 4A, the semiconductive film 21 is formed on the first insulating film (gate insulating film) 17 at given positions so as to have a given shape. To be specific, the semiconductive film 21 is formed at a position to be superimposed on the gate electrode 161, interposing the first insulating film 17 therebetween, and a position to be superimposed on the auxiliary capacitance signal line 15, interposing the first insulating film 17 therebetween. The semiconductive film 21 has the two-layer structure of the first sub-semiconductive film 211 and the second sub-semiconductive film 212. The first sub-semi conductive film 211 is preferably made of amorphous silicon and has a thickness of about 100 nm. The second sub-semiconductive film 212 is preferably made of n+ type amorphous silicon and has a thickness of about 20 nm.

The first sub-semiconductive film 211 functions as an etching stopper layer in a stage of forming the data line 12 and the drain line 14 by etching. The second sub-semiconductive film 212 improves ohmic contact with the source electrode 162 and the drain electrode 163, which are formed in a later step.

The semiconductive film 21 (the first sub-semiconductive film 211 and the second sub-semiconductive film 212) is formed preferably using a plasma CVD method and a photolithographic method. To be specific, first, the materials of which the semiconductive film 21 (the first sub-semiconductive film 211 and the second sub-semiconductive film 212) is made are deposited using the plasma CVD method on the one surface of the transparent substrate 11 subjected to the precedent stages. Then, the formed semiconductive film 21 (the first sub-semiconductive film 211 and the second sub-semiconductive film 212) is subjected to patterning so as to have the given shape using the photolithographic method. Thus, the semiconductive film 21 (the first sub-semiconductive film 211 and the second sub-semiconductive film 212) is superimposed on the gate electrode 161 and the auxiliary capacitance signal line 15, interposing the first insulating film 17 therebetween.

Next, as shown in FIG. 4B, the data line (source line) 12, the drain line 14, and the source electrode 162 and the drain electrode 163 of the TFT 16 are formed. First, a conductive film (hereinafter, referred to as a “second conductive film”) that is to become the data line 12, the drain line 14, and the source electrode 162 and the drain electrode 163 of the TFT 16 is formed on the one surface of the transparent substrate 11 subjected to the precedent stages. Then, the formed second conductive film is subjected to patterning so as to have given shapes.

The second conductive film has a laminated structure of two or more layers preferably made of titanium, aluminum, chromium and molybdenum. In the substrate 1 according to the preferred embodiment of the present invention, the second conductive film has a two-layer structure. To be specific, the second conductive film has the two-layer structure of a first sub-conductive film that is closer to the transparent substrate 11 and a second sub-conductive film that is closer to the pixel electrode 20. The first sub-conductive film is preferably made of titanium, and the second sub-conductive film is preferably made of aluminum.

The second conductive film is formed preferably using a sputtering method. Examples of the patterning of the second conductive film include wet etching using CH₃COOH+HNO₃+H₃PO₄ and dry etching using BCl₃ gas or Cl₂ gas. After the patterning, the data line 12, the drain line 14, and the source electrode 162 and the drain electrode 163 of the TFT 16 are formed. Then, the second sub-conductive film formed on a channel region between the source electrode 162 and the drain electrode 163 is removed using the pattern of the formed second conductive film as a mask by dry etching using Cl₂ gas.

Through these stages, the TFT 16 (the gate electrode 161, the source electrode 162 and the drain electrode 163), the data line 12, the scanning line 13, the drain line 14 and the auxiliary capacitance signal line 15 are formed on the one surface of the transparent substrate 11 as shown in FIG. 4B.

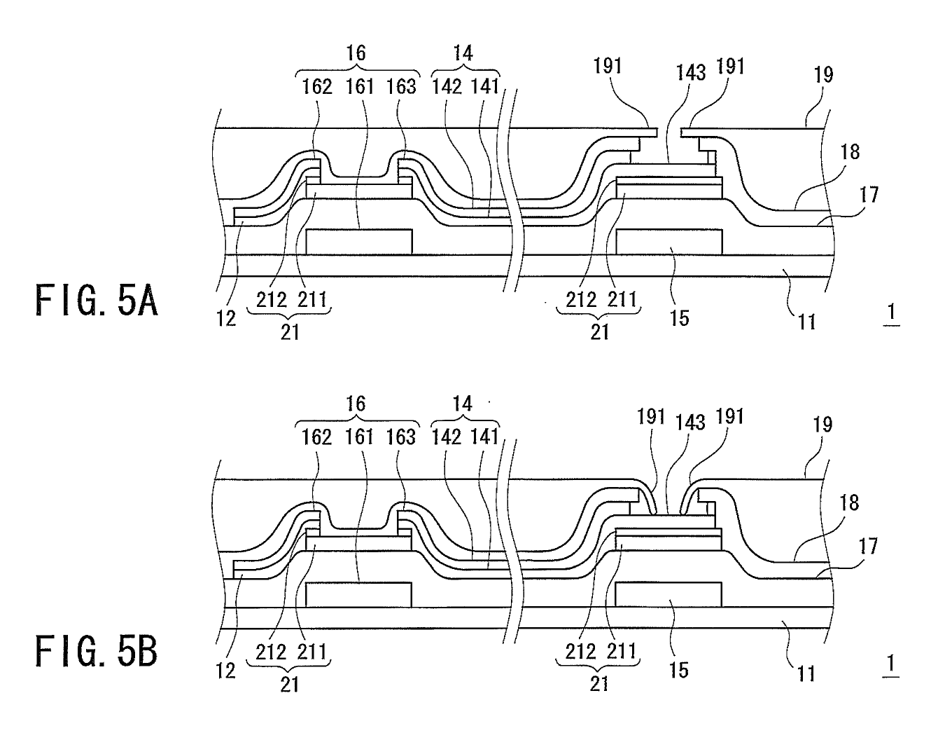

Then, as shown in FIG. 5A, the second insulating film (i.e., passivation film) 18 and the third insulating film (i.e., organic insulating film) 19 are formed on the one surface of the transparent substrate 11 subjected to the precedent stages.

The second insulating film 18 is firstly formed on the one surface of the transparent substrate 11 subjected to the precedent stages. The second insulating film 18 is preferably made of SiNx (silicon nitride) and has a thickness of about 400 nm. The second insulating film 18 is formed preferably using a plasma CVD method. After the second insulating film 18 is formed, the third insulating film 19 is formed thereon. The third insulating film 19 is preferably made of an acrylic resin material.

The formed third insulating film 19 is subjected to patterning so as to have the given shape preferably using a photolithographic method. In this patterning, the opening (contact hole) through which electric current passes between the pixel electrode 20 and the drain line 14 is formed in the third insulating film 19. A given portion of the second insulating film 18 is exposed from the opening (contact hole) of the third insulating film 19. Thus, the second insulating film 18 is subjected to patterning using as a mask the third insulating film 19 subjected to the patterning. Following the patterning of the second insulating film 18, the opening is formed in the second sub-conductive film 142 of the drain line 14.

In this patterning, the portion of the second insulating film 18 that is exposed from the opening (contact hole) of the third insulating film 19 is removed. Thus, the opening is formed also in the second insulating film 18. From the opening (contact hole) formed in the second insulating film 18, a portion of the second sub-conductive film 142 of the drain line 14 is exposed. The exposed portion of the second sub-conductive film 142 of the drain line 14 is removed to form the opening. Thus, the first sub-conductive film 141 is exposed from the openings (contact holes) of the second insulating film 18 and the third insulating film 19. The patterning of the second sub-conductive film 142 is performed preferably by dry etching using SF₆+O₂.

During the formation of the opening of the second sub-conductive film 142, the second insulating film 18 and the second sub-conductive film 142 are subjected to undercut (also referred to as “side etching”).

When the second insulating film 18 is subjected to the undercut, the circumference (rim) of the opening (contact hole) of the second insulating film 18 is located outer than the circumference (rim) of the opening (contact hole) of the third insulating film 19. In other words, the circumference (rim) of the opening (contact hole) of the third insulating film 19 is located inner than the circumference (rim) of the opening (contact hole) of the second insulating film 18. As a result of the undercut of the second insulating film 18, the third insulating film 19 includes the protruding portion 191 that protrudes inward further than the circumference (rim) of the opening of the second insulating film 18.

Next, as shown in FIG. 5B, the transparent substrate 11 subjected to the precedent stages is subjected to curing (or heat treatment). By being subjected to the curing (or heat treatment), the third insulating film 19 is softened. Being in midair, the protruding portion 191 of the softened third insulating film 19 is deformed under its own weight, and the end of the protruding portion 191 bends so as to hang down toward the drain line 14. In the contact holes, the first sub-conductive film 141 is exposed therefrom because the opening is formed in the second sub-conductive film 142 of the drain line 14. Consequently, the end of the protruding portion 191 is brought into physical contact with the first sub-conductive film 141 of the drain line 14. Thus, the inside surface (rim) of the opening of the second sub-conductive film 142 of the drain line 14 is covered with the third insulating film 19.

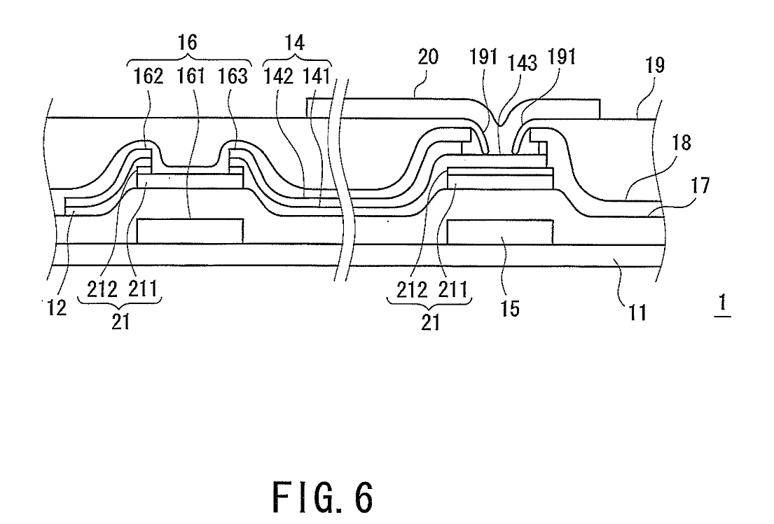

Then, as shown in FIG. 6, the pixel electrode 20 is formed. The pixel electrode 20 is formed also in the inside of the contact holes formed in the precedent stages (i.e., formed also on the exposed first sub-conductive film 141 of the drain line 14). The pixel electrode 20 is preferably made of ITO (Indium Tin Oxide) and has a thickness of about 90 nm. The pixel electrode 20 is formed preferably using a known sputtering method.

Thus, the first sub-conductive film 141 of the drain line 14 is in physical contact with the pixel electrode 20, so that electric current passes between the drain line 14 and the pixel electrode 20. Meanwhile, the inside surface of the second sub-conductive film 142 of the drain line 14 and the pixel electrode 20 are not in physical contact with each other. Consequently, electrolytic corrosion can be prevented from occurring between the second sub-conductive film 142 of the drain line 14 and the pixel electrode 20.

In addition, because this configuration eliminates a need to form an opening in the first sub-conductive film 141 of the drain line 14, the auxiliary capacitance can be increased, or the auxiliary capacitance can be increased without increasing the size (outside dimension) of the pad portion 143 of the drain line 14. In addition, the auxiliary capacitance can be prevented from reducing even when the size (outside dimension) of the pad portion 143 of the drain line 14 is reduced.

The substrate 1 according to the preferred embodiment of the present invention is manufactured through these stages.

Next, a description of a method for manufacturing a display panel according to another preferred embodiment of the present invention that includes the substrate according to the above-described preferred embodiment of the present invention will be provided.

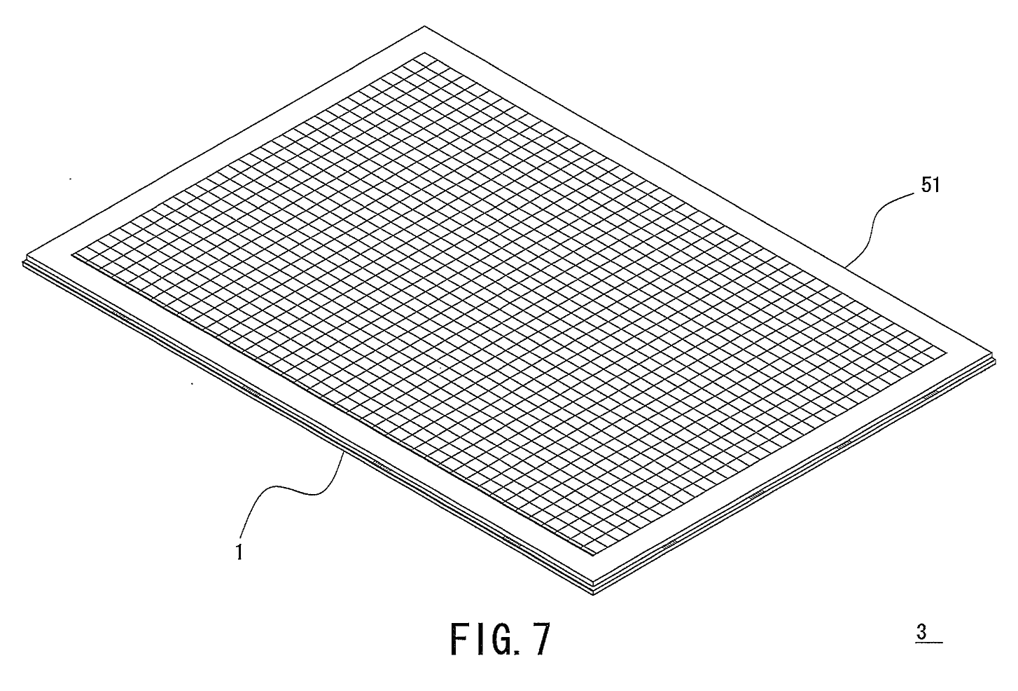

FIG. 7 is an external perspective view showing a schematic configuration of a display panel 3 including the substrate 1 according to the preferred embodiment of the present invention. As shown in FIG. 7, the display panel 3 includes the TFT array substrate (the substrate 1 according to the preferred embodiment of the present invention) and a color filter (a common substrate 51). Liquid crystals are filled between the substrates. A detailed description of the configuration of the display panel 3 is omitted because a configuration of a general liquid crystal display panel can be applied to the display panel 3.

The method for manufacturing the display panel according to the preferred embodiment of the present invention includes the steps of manufacturing the TFT array substrate, manufacturing the color filter, and manufacturing a panel (cell). The step of manufacturing the TFT array substrate is as described above.

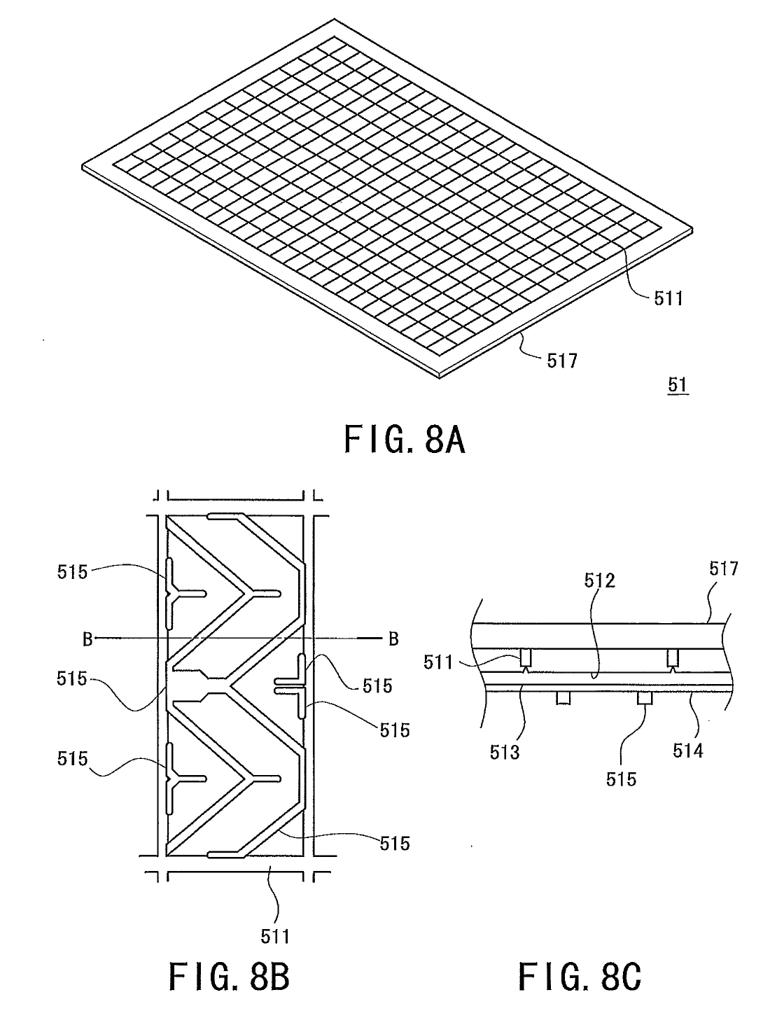

Descriptions of the configuration of the color filter and the step of manufacturing the color filter will be provided. FIGS. 8A, 8B and 8C are views showing a schematic configuration of the common substrate (color filter) 51. To be specific, FIG. 8A is a perspective view showing a schematic configuration of the entire common substrate (color filter) 51. FIG. 8B is a plan view showing a configuration of one pixel among pixels provided on the common substrate (color filter) 51. FIG. 8C is a cross-sectional view showing a cross-sectional configuration of the pixel along the line B-B of FIG. 8B.

As shown in FIG. 8A, in the common substrate (color filter) 51, a black matrix 511 is arranged in a lattice pattern on a transparent substrate 517 that is preferably made of glass. Color layers 512 that are made of color resists of red, green, and blue colors are each provided in lattice cells of the black matrix 511. The lattice cells of the color layers 512 of red, green, and blue colors are arranged in a given order. A protection film 513 is provided on the black matrix 511 and the color layers 512. A transparent electrode (common electrode) 514 is provided on the protection film 513. Alignment control structural elements 515 arranged to control alignment of the liquid crystals are provided on the transparent electrode (common electrode) 514.

The step of manufacturing the color filter includes the stages of black matrix formation, color layer formation, protection film formation, and transparent electrode (common electrode) formation.

The stage of black matrix formation in a resin BM process, for example, is described. First, a BM photoresist (a photosensitive resin composition containing a black coloring agent) is coated on the transparent substrate 517. Then, patterning is performed on the coated BM photoresist preferably using a photolithographic method so as to have a given pattern. Thus, the black matrix having the given pattern is obtained.

In the stage of color layer formation, the color layers 512 of red, green and blue colors for color display are formed. The stage of color layer formation in a color resist method, for example, is described. First, a color resist (i.e., a solution prepared by dispersing a pigment of a given color into a photosensitive material) is coated on the transparent substrate 517 on which the black matrix 511 is formed. Then, patterning is performed on the coated color resist preferably using a photolithographic method so as to have a given pattern. This stage is repeated for each of red, green and blue colors. Thus, the color layers 512 of red, green and blue colors are obtained.

The method used in the stage of black matrix formation is not limited to the resin BM process. Various known methods such as a chromium BM method and an overlap method can be preferably used. The method used in the stage of color layer formation is not limited to the color resist method. Various known methods such as a printing method, a dyeing method, an electrodeposition method, a transfer method and a photo-etching method can be preferably used. It is also preferable to use a back-face exposure method in which the color layers 512 are formed first and the black matrix 511 is formed subsequently.

In the stage of protection film formation, the protection film 513 is formed on the black matrix 511 and the color layers 512 preferably using a method in which a protection film material is coated on the transparent substrate 517 subjected to the precedent stages with the use of a spin coater (an overcoating method), and a method for forming the protection film having a given pattern preferably in a printing method and a photolithographic method (a patterning method). The protection film material is preferably an acrylate resin and an epoxy resin.

In the stage of transparent electrode (common electrode) formation, the transparent electrode (common electrode) 514 is formed on the protection film 513 preferably using a masking method. To be specific, a mask is placed on the transparent substrate 517 subjected to the precedent stages, and ITO (Indium Tin Oxide) is evaporated onto the mask preferably using a sputtering method to form the transparent electrode (common electrode) 514.

Then, the alignment control structural elements 515 are formed preferably using a photolithographic method. A photosensitive material is coated on the transparent substrate 517 subjected to the precedent stages. The coated photosensitive material is exposed to light through a photomask so as to have a given pattern. Then, unnecessary portions are removed therefrom in a subsequent stage of development, and the alignment control structural elements 515 having the given pattern are obtained.

The common substrate (color filter) 51 is manufactured through these stages.

Next, a description of the step of manufacturing the panel (cell) will be provided. Alignment layers are each formed on the TFT array substrate (substrate 1 according to the preferred embodiment of the present invention) and the common substrate (color filter) 51 that are manufactured through the above-described stages. The formed alignment layers are subjected to alignment processing. Then, the substrate 1 according to the preferred embodiment of the present invention and the common substrate (color filter) 51 are bonded together, and liquid crystals are filled between the substrates.

The alignment layers are formed on the substrate 1 according to the preferred embodiment of the present invention and the common substrate (color filter) 51 in the following manner. First, an alignment layer material is coated on both of the substrate 1 according to the preferred embodiment of the present invention and the common substrate (color filter) 51 preferably using an alignment layer material coating device. An alignment layer material refers to a solution that contains a substance from which an alignment layer is made. Examples of the alignment layer material coating device include conventional devices such as a cylinder-type press machine and an ink-jet press machine. Then, the coated alignment layer material is heated and baked preferably using a baking system.

Next, the baked alignment layers are subjected to the alignment processing. Examples of the alignment processing include various known processing methods such as a method in which tiny scratches are made on an alignment layer using a rubbing roll, and optical alignment processing in which surface properties of an alignment layer are adjusted by irradiating light energy such as ultraviolet onto the surface of the alignment layer.

Then, a sealing material is coated on either one of the substrate 1 according to the preferred embodiment of the present invention and the common substrate (color filter) 51 preferably using a seal patterning device.

Spacers for maintaining a cell gap uniform at a given thickness are sprayed on either one of the substrate 1 according to the preferred embodiment of the present invention and the common substrate (color filter) 51 preferably using a spacer sprayer. The liquid crystals are drop-filled in a region surrounded by the sealing material on the either one of the substrate 1 according to the preferred embodiment of the present invention and the common substrate (color filter) 51 preferably using a liquid crystal drop fill device.

Then, the substrate 1 according to the preferred embodiment of the present invention and the common substrate (color filter) 51 are bonded together in a reduced-pressure atmosphere. It is also preferable that the liquid crystals are filled between the substrate 1 according to the preferred embodiment of the present invention and the common substrate (color filter) 51 after the sealing material is subjected to solidification.

The display panel 3 according to the preferred embodiment of the present invention is manufactured through these stages.

The foregoing descriptions of the preferred embodiments of the present invention have been presented for purposes of illustration and description with reference to the drawings. However, it is not intended to limit the present invention to the preferred embodiments, and modifications and variations are possible as long as they do not deviate from the principles of the present invention.

1. A substrate for a display panel that comprises:
a first conductive film;
a second conductive film that is superimposed on the first conductive film and comprises an opening; and
an insulating film that is superimposed on the second conductive film and comprises an opening,
the first conductive film being exposed from the openings of the second conductive film and the insulating film, a rim of the opening of the second conductive film being covered with the insulating film.

2. The substrate according to claim 1, wherein a rim of the opening of the insulating film is in contact with the first conductive film.

3. The substrate according to claim 1, wherein a rim of the opening of the insulating film comprises a portion having the shape of an eave that protrudes further than the rim of the opening of the second conductive film, and the eave-shaped portion covers the rim of the opening of the second conductive film.

4. The substrate according to claim 3, wherein the eave-shaped portion is in contact with the first conductive film.

5. The substrate according to claim 1, wherein the insulating film has a laminated structure and comprises a lower insulating film and an upper insulating film, the rim of the opening of the lower insulating film and the rim of the opening of the second conductive film being covered with the upper insulating film.

6. The substrate according to claim 1, further comprising a third conductive film that is superimposed on the insulating film, and is electrically connected with the first conductive film at the openings of the insulating film and the second conductive film.

7. The substrate according to claim 1, wherein the first conductive film and the second conductive film each comprise portions of a drain line, and the insulating film comprises a passivation film.

8. The substrate according to claim 6, wherein the third conductive film comprises a pixel electrode.

9. The substrate according to claim 1, wherein the first conductive film and the second conductive film are made of materials that have different ionization tendencies.

10. The substrate according to claim 5, wherein the upper insulating film is made of a resin material.

11. A substrate for a display panel that comprises:
a conductive film that has a laminated structure and comprises a lower sub-conductive film and an upper sub-conductive film, the upper sub-conductive film comprising an opening; and
an insulating film that comprises a portion that is superimposed on the conductive film, and an opening,
the lower sub-conductive film being exposed from the openings of the upper sub-conductive film and the insulating film, a rim of the opening of the upper sub-conductive film being covered with the insulating film.

12. The substrate according to claim 11, wherein a rim of the opening of the insulating film is in contact with the lower sub-conductive film.

13. The substrate according to claim 11, wherein a rim of the opening of the insulating film comprises a portion having the shape of an eave that protrudes further than the rim of the opening of the upper sub-conductive film, and the eave-shaped portion covers the rim of the opening of the upper sub-conductive film.

14. The substrate according to claim 13, wherein the eave-shaped portion is in contact with the lower sub-conductive film.

15. The substrate according to claim 11, wherein the insulating film has a laminated structure and comprises a lower insulating film and an upper insulating film, the rim of the opening of the lower insulating film and the rim of the opening of the upper sub-conductive film being covered with the upper insulating film.

16. The substrate according to claim 11, further comprising a third conductive film that is superimposed on the insulating film, and is electrically connected with the lower sub-conductive film at the openings of the insulating film and the upper sub-conductive film.

17. The substrate according to claim 11, wherein the lower sub-conductive film and the upper sub-conductive film each comprise portions of a drain line, and the insulating film comprises a passivation film.

18. The substrate according to claim 16, wherein the third conductive film comprises a pixel electrode.

19. The substrate according to claim 11, wherein the lower sub-conductive film and the upper sub-conductive film are made of materials that have different ionization tendencies.

20. The substrate according to claim 15, wherein the upper insulating film is made of a resin material.

21. A display panel that comprises:
the substrate according to claim 1;
a common substrate that is opposed to the substrate, leaving a given gap therebetween; and
liquid crystals that are filled between the substrates.

22. A method for manufacturing a substrate for a display panel, the method comprising the steps of:
forming a first conductive film;
forming a second conductive film that is superimposed on the first conductive film;
forming an insulating film that comprises a portion superimposed on the second conductive film;
forming an opening in the insulating film;
forming an opening in the second conductive film to expose the first conductive film; and
thermally deforming the insulating film, and covering a rim of the opening of the second conductive film with a rim of the opening of the insulating film.

23. A method for manufacturing a substrate for a display panel, the method comprising the steps of:
forming a first conductive film;
forming a second conductive film that is superimposed on the first conductive film;
forming an insulating film that comprises a portion superimposed on the second conductive film;
forming an opening in the insulating film;
forming an opening in the second conductive film to expose the first conductive film; and
thermally deforming the insulating film, covering a rim of the opening of the second conductive film with a rim of the opening of the insulating film, and bringing the rim of the opening of the insulating film into contact with the exposed first conductive film.

24. A method for manufacturing a substrate for a display panel, the method comprising the steps of:
forming a conductive film that comprises a lower sub-conductive film and an upper sub-conductive film;
forming an insulating film that comprises a portion superimposed on the conductive film;
forming an opening in the insulating film;
forming an opening in the upper sub-conductive film to expose the lower sub-conductive film; and
thermally deforming the insulating film, and covering a rim of the opening of the upper sub-conductive film with a rim of the opening of the insulating film.

25. A method for manufacturing a substrate for a display panel, the method comprising the steps of
forming a conductive film that comprises a lower sub-conductive film and an upper sub-conductive film;
forming an insulating film that comprises a portion superimposed on the conductive film;
forming an opening in the insulating film;
forming an opening in the upper sub-conductive film to expose the lower sub-conductive film; and
thermally deforming the insulating film, covering a rim of the opening of the upper sub-conductive film with a rim of the opening of the insulating film, and bringing the rim of the opening of the insulating film into contact with the exposed lower sub-conductive film.

26. A method for manufacturing a display panel comprising the method according to claim 22.
